(19) United States
(12) Patent Application Publication
(10) Pub. No.: US 2015/0233143 A1
(43) Pub. Date: Aug. 20, 2015

(54) HANDLE

(71) Applicants: Doug Johnson, Grandville, MI (US); Clarke Crump, Dorr, MI (US)

(72) Inventors: Doug Johnson, Grandville, MI (US); Clarke Crump, Dorr, MI (US)

(21) Appl. No.: 14/180,391

(22) Filed: Feb. 14, 2014

(51) Int. Cl. E05B 1/04

(52) U.S. Cl. CPC E05B 1/04

(57) ABSTRACT

An appliance handle assembly is comprised of a base which is the mounting structure and may also the back or under side of the curved handle. It is fastened to the appliance door by a various fastening methods. The assembly includes a cover component the edge of which springs over and past the tangent point of the base locking it onto the base. The cover edge fits into a recess in the base to prevent exposure to the edge. The cover can be applied after fasteners have been installed. The cover may hide the fastening device and may be also removable by optional access notch to reveal the fastener as required. The base may be colored and textured to either match or contrast the cover as preferred by appliance designer. The simple assembly can be completed by the appliance manufacturer or by the end consumer.

### RELATED APPLICATION

This continuation in part patent application claims priority from a patent application filed on 6 Mar. 2012, application Ser. No. 13/412,961, which claims priority from a provisional patent application filed on 9 Mar. 2011, application No. 61/450,981.

### GOVERNMENT RIGHTS

This invention was not made with Government support. The Government does not have any rights in this invention.

### BACKGROUND OF THE INVENTION

Current designs are typically all plastic or steel material and are limited on manufacturing, design and mounting options based upon the material. Current designs using base and cover typically include large steps and mismatch between components.

Welding adds cost to manufacturing as compared to making the same part without welding.

With most stainless steel handles, after forming into the desired shape, there is need for post formation polishing to obtain an even stainless steel look throughout the part. Typical stainless finishes are “brushsed” or “bright” finishes.

With most handles, there are set screws used to secure the handle cover to its base.

There is a need for a handle and handle cover that is made without welding.

There is a need for a handle and handle cover that is made without the need for post polishing.

There is a need for a handle cover with concealed mounting, in other words, no visible set screws or set screw holes. The set-screw retention mounting is the most widely used mounting option at present. In a further embodiment the set-screw may be visible. Many current handles have only one mounting option—set-screw retention.

There exists a need for a handle and base that costs less to produce.

What is needed is a snap on cover for a handle.

There is also a need for a slide on cover for a handle.

The present invention addresses these needs.

### SUMMARY OF THE INVENTION

One aspect of the present invention is a handle 10, comprising: a base 20, said base 20 having a means of fastening to a surface 110, said base having a base width 120; and a cover 40, said cover 40 having a cover width 130 and being removably attached to said base.

Another aspect of the present invention is a handle 10, comprising: a base 20, said base 20 having a means of fastening to a surface 110, said base having a width 120; a cover 40, said cover 40 having a cover width 130 and being removably attached to said base 20; said cover width 130 being not greater than said base width; said base 20 having at least one of the following, either an offset 70 or a catch 80; said cover 40 having an edge 140; said edge 140 contacts at least one of said offset 70 or said catch 80 and said edge 140 is removably secured to at least one of either said offset 70 or catch 80 because of a compression force between said edge 140 and said offset 70 or said catch 80; said cover 40 is C-shaped; said base 20 have a plurality of ribs 60; wherein said cover 40 does not contact a door 30 when said cover 40 is removably secured to said base 20.

### BRIEF DESCRIPTION OF THE DRAWINGS

FIG. 1 is a perspective view of an appliance door-drawer front including the door handle of this invention.

FIG. 2 is a plan view of the door including handle of FIG. 1.

FIG. 3 is a sectional view taken along line 3-3 of FIG. 3

FIG. 4 is a sectional view taken along line 4-4 of FIG. 3

FIG. 4A is an enlarged view taken from FIG. 4.

FIG. 5 is a sectional view taken along line 5-5 of FIG. 3.

FIG. 5A is an enlarged view taken from FIG. 5.

FIG. 5C is an enlarged pre-assembled sectional view along line 5-5 of FIG. 3.

FIG. 5D is an enlarged assembled sectional view along line 5-5 of FIG. 3.

FIG. 6 is an enlargement of view circle 5 of FIG. 3.

FIG. 6A is an enlargement of view circle 6A of FIG. 6.

FIG. 7 is a shaded perspective view of the handle of this invention.

FIG. 7A is an enlargement of view circle 7A of FIG. 7.

FIG. 8 is an exploded view of the handle of this invention.

### DETAILED DESCRIPTION OF THE INVENTION

### Reference Numerals

10 handle
20 base
30 door
40 cover
50 fastener
60 rib
70 offset
80 catch
90 angled portion
100 release slot
110 means of fastening to a surface
120 base width
130 cover width
140 edge
150 first wall
160 second wall
170 non-angled portion
180 flush surface
190 gap

The following detailed description is of the best currently contemplated modes of carrying out the invention. The description is not to be taken in a limiting sense, but is made merely for the purpose of illustrating the general principles of the invention, since the scope of the invention is best defined by the appended claims.

Certain terminology will be used in the following description for convenience and reference only, and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the system and designated parts. Said terminology will include the words specifically mentioned, derivatives, and similar words. Also, “connected to,” “secured to,” or similar language includes the definitions “indirectly connected to,” “directly connected to,” “indirectly secured to,” and “directly secured to.”

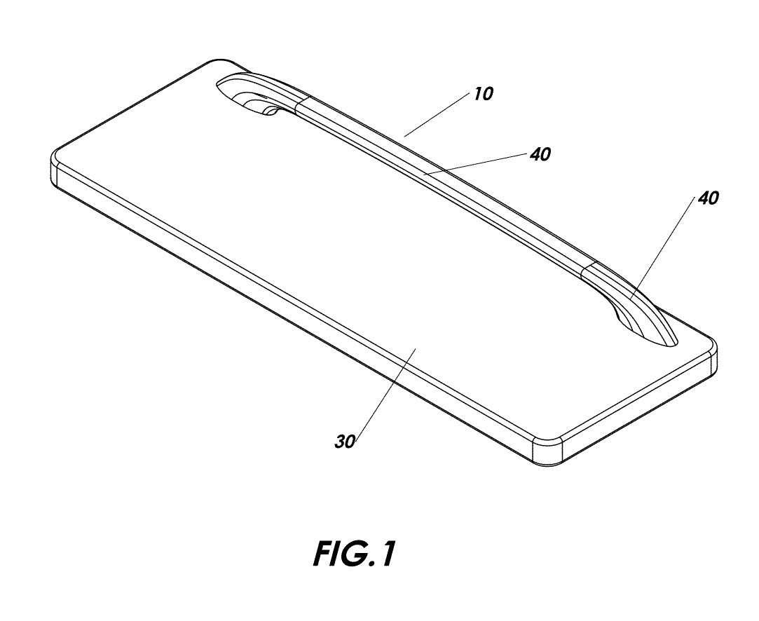

FIG. 1 illustrates one embodiment of the handle 10 of the present invention 10 attached to a door 30. The cover 40 is illustrated secured to the base 20 (not illustrated in this figure), and the base 20 secured to the door 30.

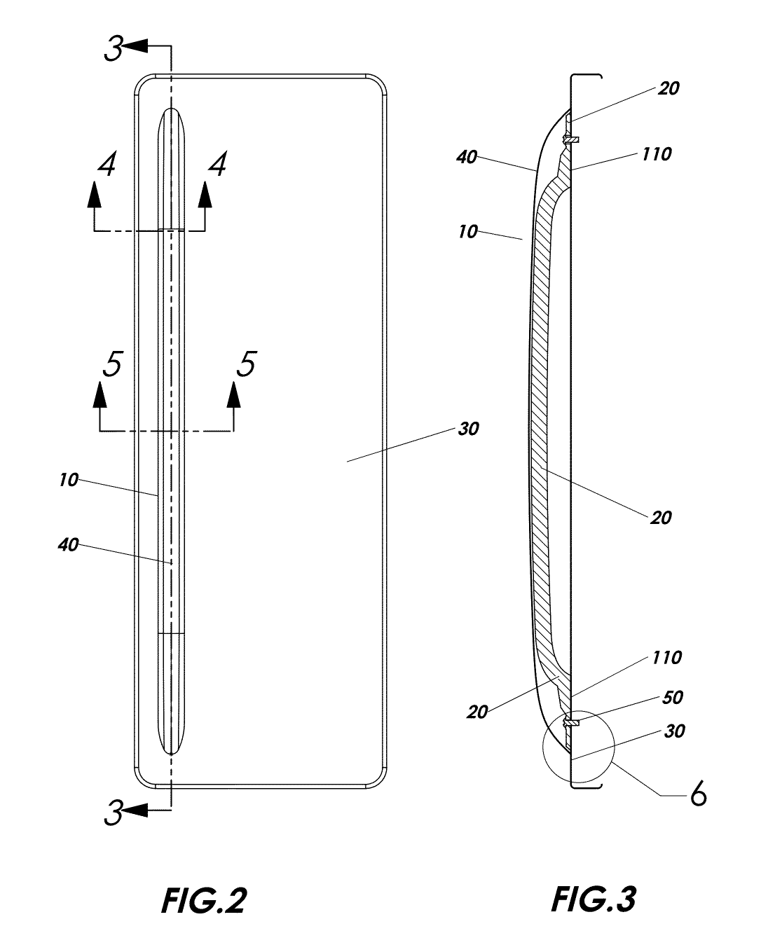

FIG. 2 illustrates an embodiment of the present invention 10 connected to a door 30.

FIG. 3 illustrates a cross sectional view from line 3-3. The cover 40 is shown with respect to the base 20. The means of fastening to a surface 110 connects the base 20 to a door 30. In one embodiment the means of fastening to a surface 110 may be a fastener 50, such as a screw. The means of fastening to a surface 110 may also include means such as magnets, snap features, clips, or any other means.

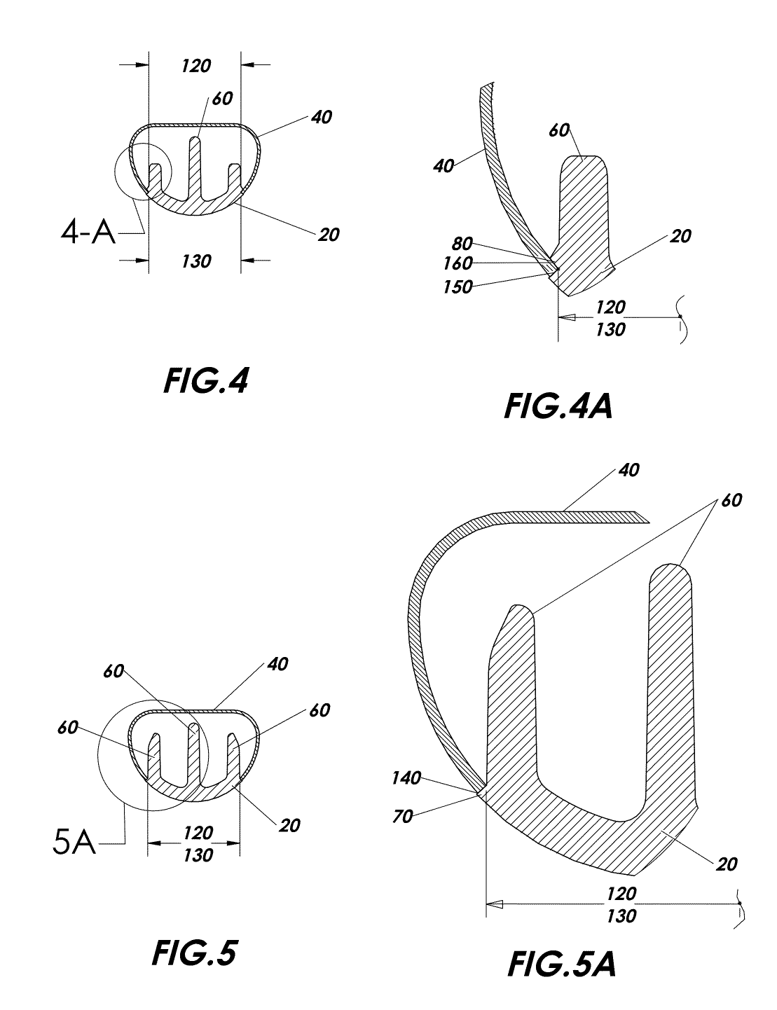

FIG. 4 illustrates a cross sectional view along line 4-4. This illustrates the present invention 10 with the base 20 having a base width 120, and the cover 40 having a cover width 130. Three ribs 60 are illustrated as extending upwardly from the base 20. The ribs may provide support and stiffening of the base 20 and also the cover 40.

FIG. 4A is a close up view of a portion of FIG. 4. A catch 80 is formed from the base 20 and is adjacent to the rib 60. The catch 80 is formed from a first wall 150 and a second wall 160 that is substantially perpendicular with respect to the first wall 150, to form a catch 80 that can receive the edge 140 of the cover 40. The cover 40 is secured to the catch 80 because the cover width 130 is slightly less than the base width 120, which causes an interference fit with respect to the cover 40 and the base 20. In other words, each edge 140 of the cover 40 is flexed outwardly to fit onto the base 20, particularly the catch 80, which causes a compression force to be applied to the catch 80, which maintains a tight and snug fit between the cover 40 and the base 20. The catch 80 may be disposed on opposed sides of the base 20 and may run longitudinally on the base 20. Alternatively the catch 80 may be intermittent segments disposed on the base 20 rather than one long continuous catch 80.

The ribs 60 are also illustrated as extending upwardly from the base 20. In this embodiment the base width 120 may be congruent with the cover width 130 as see in FIG. 4A.

In another embodiment, the catch 80 may be included at various intervals as required for the application.

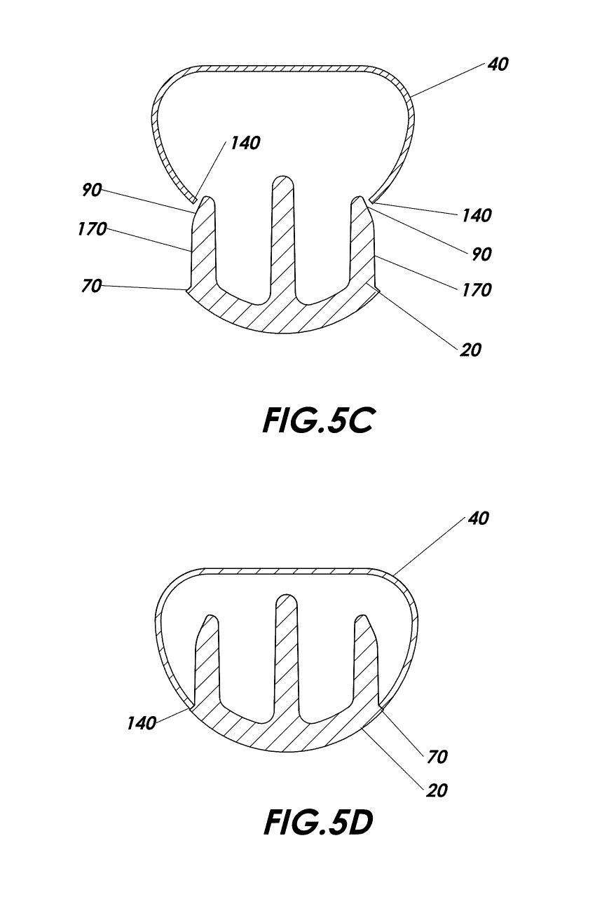

FIG. 5 illustrates a different embodiment of the present invention 10 where the base 20 has an offset 70, rather than a catch 80. This can certainly be a different embodiment. In this case it is the area between the segments where catch 80 is applied. FIG. 5 illustrates the base 20 having a base width 120 and ribs 60 extending upwardly therefrom. FIG. 5 also illustrates the cover width 130 and cover 40.

FIG. 5A illustrates a close up view of FIG. 5. The base 20 has an offset 70 on opposed sides running longitudinally. The cover 40 may be C-shaped, and have two edges 140. The distance between the edges 140 may be equal to the cover width 130. With this embodiment the base has an offset 70 that may run longitudinally along the sides of the base 20. The offset 70 may receive the edge 140. The cover width 130 may be less then the base width 120 so as to form an interference fit with respect to the offset 70 and the edge 140. The cover width 130 may be disposed downwardly from the base width 120.

FIG. 5C illustrates the cover 40 having its two opposed edges 140 shown not connected to the base 20. The base 20 has the two apposed offsets 70 disposed longitudinally substantially parallel to a longitudinal axis of the base 20. FIG. 5C also illustrates the outer most ribs 60 having an angled portion 90 that extends inwardly and upwardly from the non-angled portion 170.

FIG. 5D illustrates the cover 40 disposed on the base 20 with the edge 140 engaged with the offset 70.

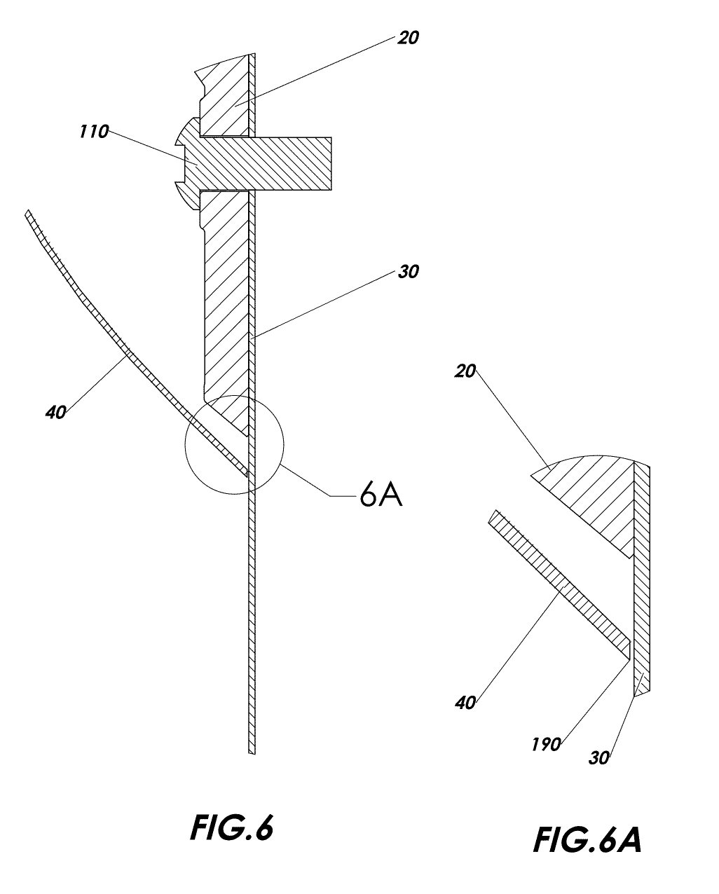

FIG. 6 illustrates the base 20 secured to a door 30 via a means of fastening to a surface 110. In this case the means of fastening to a surface 110 is a fastener 50.

In the case of the commonly used side set-screw mount, the cover 20 may not hide the fastener 50. However in another embodiment, the cover 20 may hide the fastener 50.

FIG. 6A illustrates an exploded view from FIG. 6. In FIG. 6A the cover 40 may have a flush surface 180 that is flush with the surface of the door 30. Or the cover 40 may have a slight gap 190.

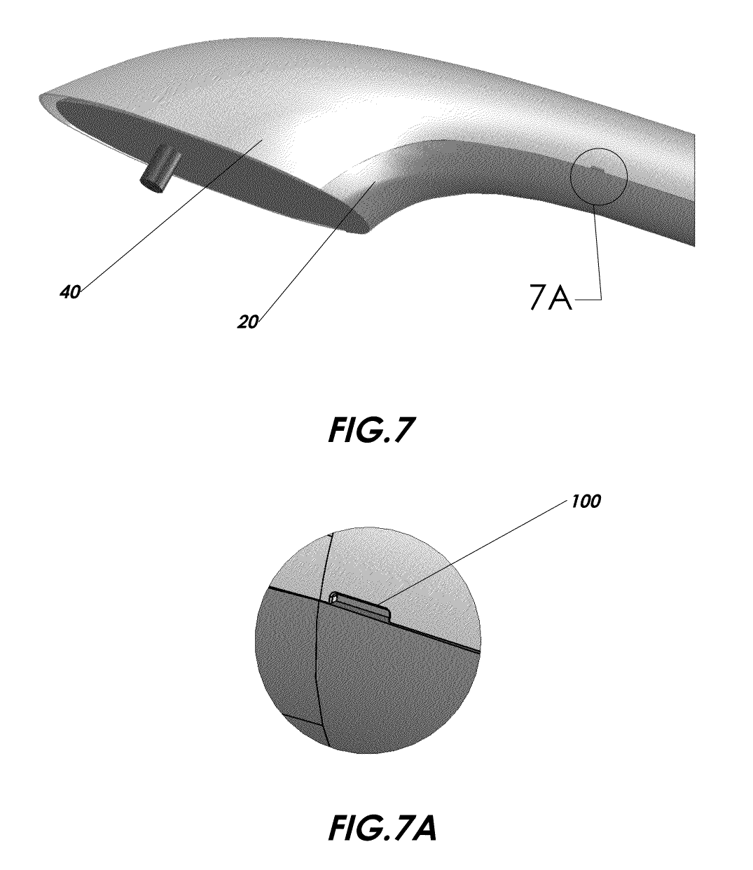

FIG. 7 illustrates a base 20 with a cover 40 connected to the base 20. The cover 40 may have a release slot 100 disposed adjacent to the base 20 so a screw driver can be placed in the release slot 100 and used to separate the cover 40 from the base 20. The release slot 100 is not a requirement depending on the geometry and the method of assembly, i.e. snap over or slide on.

FIG. 7A is an exploded view of FIG. 7. The cover 20 may be removed by using the optional release slot 100, whereby a finger or screwdriver may be used to remove the cover 20 from the base 40.

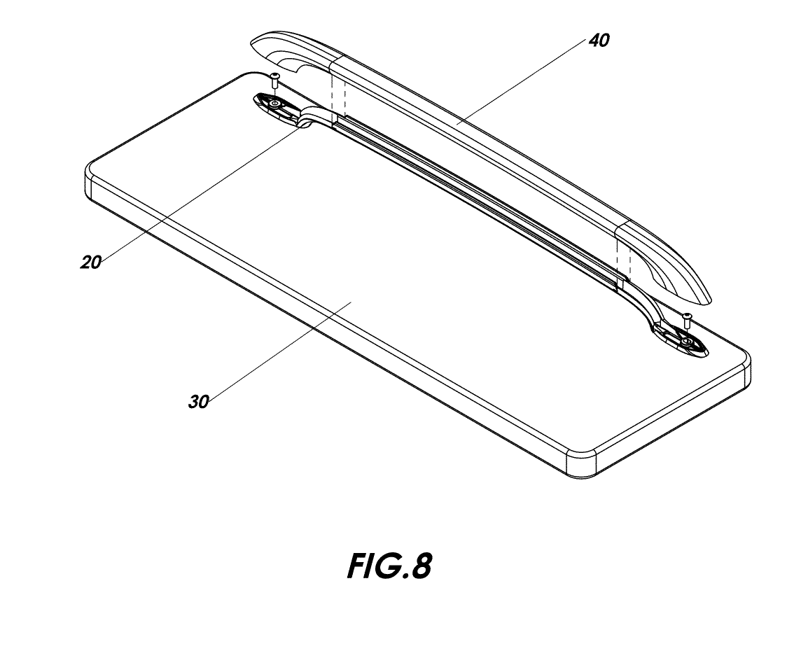

FIG. 8 illustrates a base 20 disposed on a door 30. A fastener 50 is illustrated that can secure the base 20 to the door 30. The cover 40 can be attached to the base 20 by an interference fit.

In the embodiment shown in FIG. 1, an appliance door 30 has the door-drawer handle 10 of this invention attached to the door 30. Illustrated in FIGS. 2 and 3, the handle has a base 20 with appropriate boss and/or and hole provision for mounting, such as a screw, snap on, headed stud, spring clip, etc.). The base 20 or cover 40 may be manufactured from a variety of materials, such as composite, metal, plastic or laminate material to fit the base 20 as required for fit, function, and appearance.

The cover 40 may snap over the base 20 with only the required retention for the given product application. The cover 40 may be manufactured with an over formed profile. When installed as in FIGS. 5 and 5A, the over-formed cover 40 pinches the softer base 20. The offset feature 70 of the base 20 is manufactured to a depth so that the edge of the base 20 at offset 70 projects beyond the edge of the cover 40. The base 20 is manufactured with reinforcing rib features 60 (FIGS. 5 and 5A) as needed for the application. Where the application requires a positive catch, small segments of the base 20 near the edge 140 (See FIGS. 4 and 4A) are added for a positive lock.

In this embodiment, a release slot 100 (FIGS. 7 and 7A) is included in the cover 20. The configuration and geometry of the catch feature 80 and release feature 100 is as suited to the specific sectional shape of the handle 10. Referring to FIG. 4, the cover 40 in its over-formed free state is flexed over the base 20 as it contacts the catch 80.

The cover 40 may be sized so that its edge 70 does not contact the face of the door 30 leaving the small gap 190 in FIG. 6A. Only the base 20 is in contact with the door 30. This small gap 190 is important in some applications and materials. For example, if the cover 20 is metal, it should have a gap 190 to prevent scoring of a painted surface 30. The cover 20 may also have a flush fit for some applications such as the case where the cover 20 was made of a plastic or laminate and the application was to a stainless steel door 30.

FIG. 8 represents the exploded view of this embodiment.

The present invention relates to a snap on cover, and base design with multiple material and mounting options.

The device is comprised of the following elements:

Handle 10 design of this invention has a base 20 element construction that will compliment the mounting required and the overall handle 10 construction for shape and appearance. The base 20 fits to the mounting surface or door 30 with the best mounting options relative to the product requirements. The cover 40 may be manufactured to fit the base 20 as required for fit, function and appearance. The cover 40 may snap or slide on to the base 20 with only the required retention for the given product.

The handle 10 design allows for minimal offsets and steps between the two main elements. The covers 40 can be changed or replaced for appearance and damage. The cover 40 can be removed to access the mounting components for handle removal. The cover 40 can be positioned on the top, bottom or front of the handle as mounted on the application for the most desirable seam location and appearance.

The handle 10 base 20 element is constructed of plastic or other materials that would be applicable to accommodate the attachment options for the cover 40 and overall design of the handle 10. The cover 40 is constructed and designed for the best suited materials for fit, function and appearance for the desired finished product. The handle base 20 element is mounted to the product with the best mounting option 110, such as screw on, or snap on methods, allowing the manufacturer or consumer the ability as well as the cover 40 is snapped on by the manufacturer or consumer to the handle base 30.

Said handle 10 design offers the best option for mounting for any handle design. The new handle offers multiple material and finish options with easy snap on cover design, allowing the manufacturer or consumer the option for the cover 40 material. The snap on cover 40 design minimizes gaps, offset.

Handle 10 and cover mounting could be robotically or automatically assembled. The concept could apply to knobs, drawer pulls, conventional door handles and any product that requires a cosmetic or functional cover applied over a mounting base portion of a given product.

Handles, knobs, door fronts, drawer fronts, lids, covers, drawer pulls are produced by the invention: Compositions: all materials can apply to the base or covers as desired by the manufacturer and/or consumer. The base 49 may be colored and textured to either match or contrast the cover 20 as preferred.

It should be understood, of course, that the foregoing relates to exemplary embodiments of the invention and that modifications may be made without departing from the spirit and scope of the invention as set forth in the following claims.

We claim:

1. A handle (10), comprising:
a base (20), said base (20) having a means of fastening to a surface (110), said base having a base width (120); and
a cover (40), said cover (40) having a cover width (130) and being removably attached to said base.

2. The apparatus of claim 1, further comprising:
said cover (40) having a cover width (130), said cover width (130) being not greater than said base width (120).

3. The apparatus of claim 1, further comprising:
said base (20) having a an offset (70); and
said cover (40) having an edge (140).

4. The apparatus of claim 3, wherein said edge (140) contacts said offset (70) and said edge (140) is removably secured to said offset (70) because of a compression force between said edge (140) and said offset (70).

5. The apparatus of claim 1, wherein said cover (40) is C-shaped.

6. The apparatus of claim 1, wherein said base (20) have a plurality of ribs (60).

7. The apparatus of claim 3, wherein said edge (140) contacts said offset (70) and said edge (140) is removably secured to said offset (70) because of an interference fit between said edge (140) and said offset (70).

8. The apparatus of claim 1, further comprising a catch (80) in said base (20), said catch (80) having a first wall (150) that extends upwardly and rightwardly and a second wall (160) extending upwardly and leftwardly, said second wall (160) substantially perpendicular to said first wall (150);
said cover having an edge (140);
said edge (140) removably disposed within said catch (80).

9. The apparatus of claim 1, wherein said cover (40) does not contact a door (30) when said cover (40) is removably connected to said base (20).

10. A handle (10), comprising:
a base (20), said base (20) having a means of fastening to a surface (110), said base having a width (120);
a cover (40), said cover (40) having a cover width (130) and being removably attached to said base (20);
said cover width (130) being not greater than said base width;
said base (20) having at least one of the following, either an offset (70) or a catch (80);
said cover (40) having an edge (140);
said edge (140) contacts at least one of said offset (70) or said catch (80) and said edge (140) is removably secured to at least one of either said offset (70) or catch (80) because of a compression force between said edge (140) and said offset (70) or said catch (80);
said cover (40) is C-shaped;
said base (20) have a plurality of ribs (60);
wherein said cover (40) does not contact a door (30) when said cover (40) is removably secured to said base (20).
